(19) United States
(12) Patent Application Publication
(10) Pub. No.: US 2014/0145444 A1
(43) Pub. Date: May 29, 2014

(54) APPARATUS AND METHOD FOR WAVE POWER GENERATION OF UNDERWATER TYPE

(71) Applicant: Industry-Academic Cooperation Foundation, Yonsei University, Seoul (KR)

(72) Inventors: Jin Bae Park, Gyeonggi-do (KR); Jae Man Kim, Seoul (KR); Min Kook Song, Seoul (KR); Seung Kwan Song, Seoul (KR); Jung Yoon Kim, Seoul (KR); Jae Seung Kim, Gyeonggi-do (KR)

(73) Assignee: Industry-Academic Cooperation Foundation, Yonsei University, Seoul (KR)

(21) Appl. No.: 14/089,204

(22) Filed: Nov. 25, 2013

(30) Foreign Application Priority Data
Nov. 28, 2012 (KR) 10-2012-0136245

(51) Int. Cl. F03B 13/20; F03B 13/10

(52) U.S. Cl. CPC F03B 13/20; F03B 13/10
USPC 290/53; 60/501

(57) ABSTRACT

Disclosed is an apparatus and method for wave power generation of an underwater type, which can be float underwater and can efficiently generate wave power. The apparatus includes a housing formed to have an open bottom end and fixedly connected to the seafloor, a shaft extending from a bottom surface of a top end of the housing, a floater having a top end opened to surround the shaft, positioned at a lower portion of the housing and reciprocating in a perpendicular direction with respect to the housing, and a linear generation unit converting kinetic energy based on the reciprocating motion of the floater into electrical energy.

### CROSS-REFERENCE TO RELATED APPLICATION

This application claims priority from Korean Patent Application No. 10-2012-0136245 filed on Nov. 28, 2012 in the Korean Intellectual Property Office, and all the benefits accruing therefrom under 35 U.S.C. 119, the contents of which in its entirety are herein incorporated by reference.

### BACKGROUND

1. Technical Field

The present invention relates to an apparatus and method for wave power generation of underwater type, and more particularly to a new apparatus and method for wave power generation of an underwater type, which can be float underwater and can efficiently generate wave power.

2. Description of the Related Art

Since the energy existing in nature is used as it is in generating electricity using seawater, a considerable installation cost is not incurred and the electricity generation is achieved safely. Accordingly, the electricity energy generated using seawater is drawing attention as a promising environmentally friendly future energy source.

Examples of the seawater-based power generation may include ocean current generation using the flow of water moving in constant directions, tidal generation using tidal fluctuations, wave generation using short-term, up-and-down motions of the surface of the sea by waves or heavy sea swells, and so on.

Specifically, the wave generation will now be described in detail, the wave generation is a type of power generation for converting periodical up-and-down movement of wave surfaces or back-and-forth movement of water molecules into mechanical kinetic energy using an energy conversion device to then convert the mechanical kinetic energy into electrical energy.

Most of conventional wave generation apparatuses are installed on the surface of seawater. Thus, the apparatus may be highly vulnerable to damage or loss due to natural disasters, such as wind and waves, tidal waves, etc. Wave heights of coastal areas of Korea are relatively small. Specifically, the average wave height of the east coast of Korea ranges from approximately 1.2 to approximately 1.5 m, which is smaller than that of coastal areas of Europe, i.e., 2.5 m, as evidenced by positive research into wave generation.

In general, wave generation is based on up-and-down movement of waves, magnitudes of wave heights may considerably affect the amount of power generated. In the area of sea around Korea, where the wave heights are relatively small, the effectiveness of the wave power generator installed underwater may be unavoidably lowered. Accordingly, in order to protect the apparatus from natural disasters such as wind and waves or tidal waves, it is necessary to enhance the efficiency of the wave power generator installed underwater. In addition, a wave power generator configured to prevent seawater from being induced is required, which is complex. Therefore, it is necessary to design a wave power generator capable of preventing seawater from being induced with a simplified structure.

### SUMMARY

In order to overcome the above-mentioned shortcomings, the present invention provides an apparatus and method for wave generation of an underwater type, which can be installed underwater to protect the apparatus from natural disasters such as wind and waves or tidal waves.

The present invention also provides an apparatus and method for wave generation of an underwater type, which can prevent seawater from being induced into a wave power generator with a simplified structure.

The present invention also provides an apparatus and method for wave generation of an underwater type, which can be installed even in an area having small wave heights, like in Korea, and can be floatable underwater because a seawater pressure is applied to a main body of the apparatus in a vertically upward direction.

According to an aspect of the invention, there is provided an apparatus for wave generation of an underwater type, the apparatus including a housing formed to have an open bottom end and fixedly connected to the seafloor, a shaft extending from a bottom surface of a top end of the housing, a floater having a top end opened to surround the shaft, positioned at a lower portion of the housing and reciprocating in a perpendicular direction with respect to the housing, and a linear generation unit converting kinetic energy based on the reciprocating motion of the floater into electrical energy.

According to another aspect of the invention, there is provided a method for underwater wave generation for an underwater wave generation apparatus comprising a housing formed to have an open bottom end fixedly connected to the seafloor by a rope, a floater having an open top end positioned in an inner space of a lower portion of the housing, a shaft connected to a bottom surface of a top end of the housing, a stator having a coil mounted on the shaft, and a actuator having a magnet mounted on the floater, the method comprising: the floater reciprocating under the housing by waves in a perpendicular direction with respect to the housing, the actuator moving as the floater reciprocates, and generating induced power at the stator as the actuator moves.

According to still another aspect of the invention, there is provided a method for underwater wave generation for an underwater wave generation apparatus comprising a housing having an open bottom end fixedly connected to the seafloor by a rope, a floater having an open top end positioned in an inner space of a lower portion of the housing, a shaft connected to a bottom surface of a top end of the housing, a stator having a magnet mounted on the shaft, and a actuator having a coil mounted on the floater, the method including the floater reciprocating under the housing by waves in a perpendicular direction with respect to the housing, the actuator moving according to the reciprocating of the floater, and generating induced power at the stator according to the moving of the actuator.

As described above, according to the present invention, it is possible to prevent seawater from being induced into a wave power generator with a simplified structure. With the simplified structure, maintenance and repair of the apparatus can be easily performed. In addition, since the seawater pressure is applied to a main body of the apparatus in a vertically upward direction, the main body can be floatable, thereby simply fixing the main body using a rope, etc.

In addition, a high rate of a variation in the internal volume to a variation in the wave height can be caused while maintaining the internal pressure at a relatively low level. In addition, a variation in the amplitude of an actuator of the wave power generator relative to the amplitude of the wave height can be increased, thereby increasing generation efficiency.

Further, the apparatus can be installed to be floatable underwater, so that it is not directly exposed to the surface of the sea, thereby ensuring safety of the apparatus against the marine disasters, such as wind and waves, typhoons, or tidal waves.

### BRIEF DESCRIPTION OF THE DRAWINGS

The objects, features and advantages of the present invention will be more apparent from the following detailed description in conjunction with the accompanying drawings, in which:

FIG. 1 is a cross-sectional view of an apparatus for wave generation of an underwater type according to an embodiment of the present invention;

FIG. 2 is a conceptual diagram for explaining the principle of the underwater wave generation apparatus shown in FIG. 1;

FIGS. 3A and 3B partially enlarged views for explaining the principle of power generation by the underwater wave generation apparatus shown in FIG. 1;

FIG. 4 is a flowchart of a method for wave generation of an underwater type according to an embodiment of the present invention; and

FIG. 5 is a flowchart of a method for wave generation of an underwater type according to another embodiment of the present invention.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

Hereinafter, embodiments of the present invention will be described in detail with reference to the accompanying drawings.

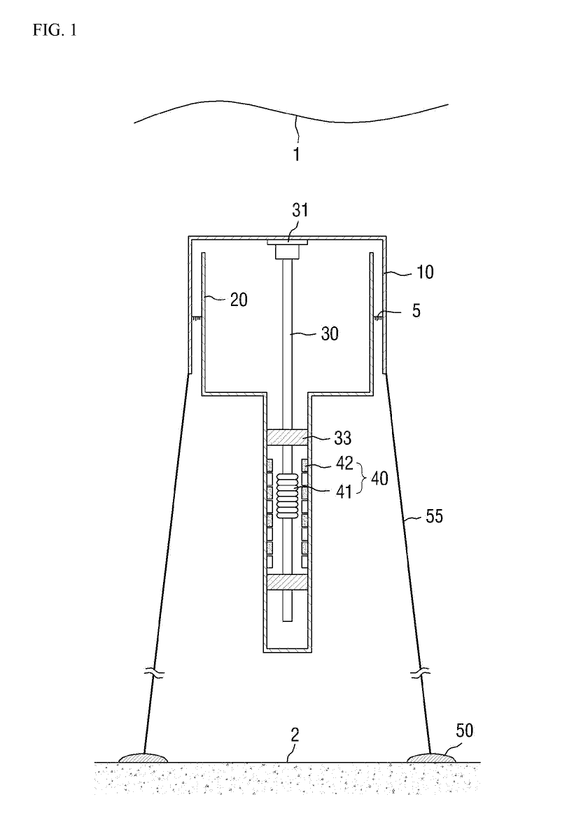

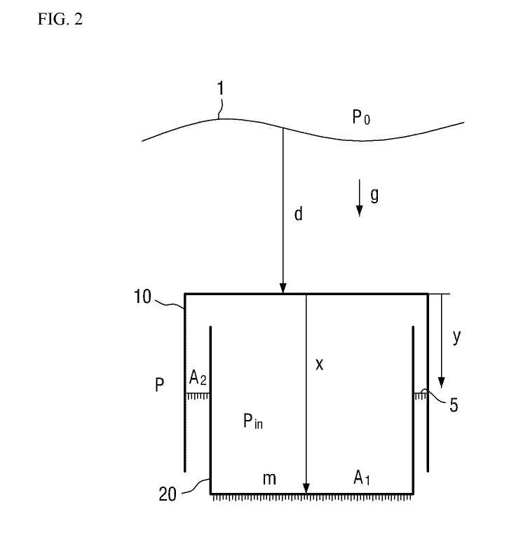

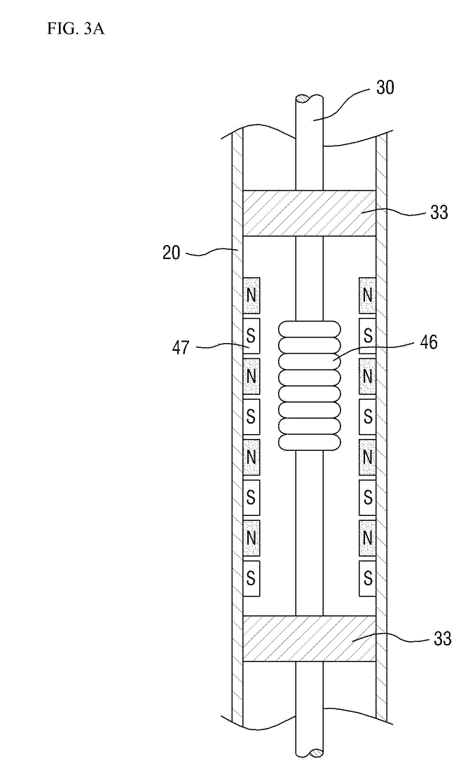

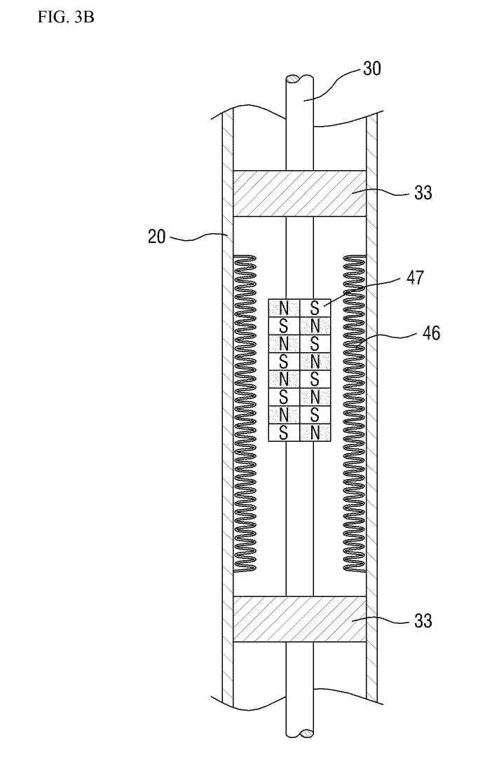

FIG. 1 is a cross-sectional view of an apparatus for wave generation of an underwater type according to an embodiment of the present invention, FIG. 2 is a conceptual diagram for explaining the principle of the underwater wave generation apparatus shown in FIG. 1, and FIGS. 3A and 3B partially enlarged views for explaining the principle of power generation by the underwater wave generation apparatus shown in FIG. 1.

Referring to FIG. 1, the underwater wave generation apparatus according to the embodiment of the present invention includes a housing 10, a floater 20, a shaft 30 and a linear generation unit 40. In addition, the underwater wave generation apparatus according to the embodiment of the present invention may further include a shaft holder 31, a bush 33, a support 50, and a rope 55.

The housing 10 forms the external appearance of the underwater wave generation apparatus and has an open bottom end to be fixedly connected to the seafloor. The floater 20, the shaft 30, etc. are positioned in the housing 10 having the opened bottom end. The housing 10 is preferably formed of a metal capable of withstanding an underwater pressure or a reinforced plastic material. In addition, in order to prevent seawater from being induced into the housing 10, a surface of the housing 10 is treated with waterproofing. The housing 10 is preferably shaped of a cylinder having a lower portion opened, but aspects of the present invention are not limited thereto.

The floater 20 has an opened top end to surround the shaft 30 extending from a bottom surface of the top end of the housing 10 and is positioned under the housing 10 to reciprocate in a perpendicular direction with respect to the housing 10. That is to say, the floater 20 moves relative to the housing 10, generating kinetic energy. In particular, the floater 20 is preferably positioned inside the housing 10. Thus, an internal space is formed by the housing 10 and the floater 20. The floater 20 is also preferably formed of a metal capable of withstanding an underwater pressure or a reinforced plastic material. In addition, in order to prevent seawater from being induced into the floater 20, a surface of the floater 20 is treated with waterproofing. In addition, the floater 20 is preferably shaped of a two-stage cylinder having an upper portion opened, but aspects of the present invention are not limited thereto. In the two-stage cylinder, a diameter of an upper portion of the cylinder is slightly smaller than that of the housing 10, and a diameter of a lower portion of the cylinder is slightly smaller than that of the upper portion of the cylinder. That is to say, the floater 20 may be shaped of a two-stage cylinder having a stepped portion. In such a manner, the upper portion of the floater 20 may serve to adjust the internal pressure, and the lower portion of the floater 20 may serve to provide a space in which the linear generation unit 40, etc. may be positioned.

The floater 20 positioned at a lower portion inside the housing 10 reciprocates in a vertical direction by a wave height 1. A separate element for achieving water-tightness is not provided between the housing 10 and the floater 20, and seawater may be induced into the space between the housing 10 and the floater 20. A seawater surface 5 needs to be positioned between the top end of the floater 20 and the bottom end of the housing 10 to prevent the internal air of the housing 10 from flowing out or to prevent seawater from penetrating into the housing 10. Therefore, it is necessary to maintain the balance between a pressure of the internal air of the housing 10 and a seawater pressure of a depth at which the housing 10 is installed, which will later be described in detail with reference to FIG. 2.

The shaft 30 is formed to extend from the bottom surface of the top end of the housing 10. Therefore, the shaft 30 is positioned in the internal space formed between the housing 10 and the floater 20. The shaft 30 may be directly connected to the housing 10. For the sake of convenient installation, a shaft holder 31 may further be provided to be fixedly connected to the shaft 30 to the bottom surface of the top end of the housing 10. In addition, the shaft 30 is preferably positioned at the center of the bottom surface of the top end of the housing 10. Since the shaft 30 is positioned at the center of the bottom surface of the top end of the housing 10, the shaft 30 serves as the central axis. In addition, the shaft 30 is formed of a bar shaped of a cylinder and is positioned lengthwise at the center of the bottom surface of the top end of the housing 10.

The linear generation unit 40 converts the kinetic energy depending on reciprocating motion of the floater 20 into electrical energy. That is to say, the linear generation unit 40 converts the kinetic energy of the floater 20 reciprocating inside the fixed housing 10 up and down by waves into the electrical energy. The linear generation unit 40 includes a stator 41 mounted on the outer surface of the shaft 30 and an actuator 42 mounted on the inner surface of the floater 20. In addition, induced power is generated by interaction between the stator 41 and the actuator 42. That is to say, the linear generation unit 40, divided into the stator 41 and the actuator 42, generates electricity while the actuator 42 reciprocates about the stator 41 (or the stator 41 performs relative movement about the actuator 42). The power generation operation and mechanism of the linear generation unit 40 will later be described in detail with reference to FIGS. 3A and 3B.

Since power generation of the linear generation unit 40 is performed by reciprocating movement of the floater 20 relative to the housing 10, it is necessary to define the limit of the reciprocating movement. The wave generation apparatus further includes a bush 33 mounted on the shaft 30 and limiting the movement of the floater 20. The bush 33 is a component concentrically inserted into the shaft 30 to limit the lengthwise motion of the shaft 30 and is preferably made of a material for reducing friction during movement. In addition, the bush 33 may be installed in pair on the shaft 30, and the linear generation unit 40 is preferably positioned between the pair of bushes 33.

The support 50 is fixedly installed on the seafloor 2, and the rope 55 connects the support 50 and the housing 10. The housing 10 can be installed at the shallow sea or coastal waters using the support 50 and the rope 55 and freely moves underwater in tune with the flow of seawater by the rope 55. That is to say, the housing 10 can freely float underwater, while the position of the housing 10 can be maintained by the tension of the rope 55. The rope 55 may be made of an iron wire or nylon so as to sufficiently withstand buoyancy of the housing 10. Since the housing 10 is freely floatable underwater, a steel frame for fixing the housing 10 on the seafloor 2 is not required, thereby saving the installation cost.

Referring to FIG. 2, the housing 10 is positioned at a depth d from the seawater surface 5. The bottom end of the housing 10 is opened, and the floater 20 is positioned inside the housing 10. Seawater may freely enter or exit between the housing 10 and the floater 20. The seawater surface 5 is kept in balance by the internal pressure of the housing 10 and seawater pressure. In FIG. 2, reference symbols d, x and y denote a depth from the seawater surface 5 to the top end of the housing 10, a distance ranging from the top end of the housing 10 to the bottom end of the floater 20, and a distance ranging from the top end of the housing 10 to the seawater surface 5.

First, the seawater surface 5 is preferably positioned at approximately half the height of the housing 10. If the seawater surface 5 is too low, the air may escape, and if the seawater surface 5 is too high, seawater may be induced into the housing 10. However, since the floater 20 should be in the state of balance, the pressure applied to and the weight of the floater 20 should be in the state of balance. In addition, the seawater surface 5 should be in the state of balance between the internal pressure and seawater pressure. Assuming that x and y in the state of balance are x₀ and y₀, respectively, the following equations (1) and (2) are given:

$$\begin{matrix}{P}_{in} + \frac{mg}{{A}_{1}} = ρ g ( d + {x}_{0} ) + {P}_{0} & ( 1 ) \\ {P}_{in} = ρ g ( d + {y}_{0} ) + {P}_{0} & ( 2 )\end{matrix}$$

where P₀, ρ, g, m denote the atmospheric pressure, the seawater density, the gravity acceleration, and the weight of the floater 20, respectively. In addition, A₁ is the area of the floater 20, and the cross-sectional area of a space which the seawater enters and exits from is defined as A₂.

The height Δ ranging from the bottom end of the floater 20 to the seawater surface 5 is defined by the following equation (3):

Δ=x₀−y₀ (3)

The following equation (4) is derived from the simultaneous equations (1) to (3):

$$Δ = \frac{m}{ρ {A}_{1}} \qquad ( 4 )$$

Assuming that the radius of the floater 20 is 0.2 m, A₁ is approximately 0.1256 m². In this case, the equation (4) is given by the following equation (5):

Δ=7.7676×m[mm] (5)

When the weight of the floater 20, i.e., m, is 50 kg, Δ of approximately 0.39 m is obtained from the equation (5). In addition, when m is 100 kg, the Δ of approximately 0.78 m is obtained from the equation (5). In order to make Δ become 0.5 m, m has only to be approximately 64.67 kg. Since m, which is the weight of the floater 20, is not affected by the installation depth of the wave generation apparatus, the internal pressure may vary. The most determinant factor for the internal pressure is d, rather than Δ. Approximately 1.1 atmospheric pressures is required in deep water where the water depth is approximately 1 m, and approximately 1.5 atmospheric pressures is required in deep water where the water depth is approximately 5 m.

Next, since the floater 20 reciprocates underwater, the seawater surface 5 varies according to the movement of the floater 20. If the variation of the seawater surface 5 exceeds the height of the floater 20, seawater may overflow into the housing 10 and the floater 20. Therefore, the variation in the seawater surface level is quite an important factor in designing the wave generation apparatus. The balance relationship between the seawater pressure and the internal pressure is given by the following equation (6):

Pᵢₙ=ρg(d+y)+P₀=(ρgd+P₀)+ρgy (6)

Assuming that the internal temperature of the housing 10 is in the isothermal state, the following equation (7) is given:

Pᵢₙ(A₁x+A₂y)=const (7)

The equations (6) and (7) are simultaneously computed, thereby obtaining the relationship between x and y, so that a quadratic equation is obtained. Since a variation in y, i.e., Δy, in the internal pressure is smaller than that in the pressure applied as a basic pressure, it can be simplified, as expressed by the following equation (8) by letting Δy be constant:

$$Δ y = \frac{{A}_{1}}{{A}_{2}} Δ x \qquad ( 8 )$$

As understood from the equation (8), a displacement of the seawater surface 5 is obtained by multiplying a displacement of the floater 20 by an area ratio for movements of the floater 20 and the seawater. For example, when a variation in the amplitude of the floater 20 is 20 cm, the area ratio should be 4:1 to make the displacement of the seawater surface 5 become 80 cm. The area ratio of 4:1 may be determined to be considerably large. However, in a case where the floater 20 is shaped of a cylinder, the area ratio may be converted in terms of radius. Then, the radius ratio may be considerably reduced. Assuming that r₁ is the radius of the floater 20 and r₂ is the radius of the housing 10, r₂ (=sqrt(5/4)*r₁) becomes approximately 1.118*r₁. That is to say, the following equation (9) can be given:

r₂=sqrt((z+1)/z)r₁ (9)

where z=y/x.

If the inner diameter of the floater 20 is variable, rather than constant, a wave generation apparatus kept in a stable state even under various circumstances can be implemented. For example, if the upper portion of the floater 20 is made to have a relatively small area, and the lower portion of the floater 20 is made to have a relatively large area, as the floater 20 rises, an increase in the seawater surface level is reduced, thereby preventing seawater from overflowing. At the same time, as the floater 20 rises, the buoyancy of the floater 20 is reduced, thereby reducing the overall buoyancy applied to the main body of the wave generation apparatus at a large wave height.

Therefore, a separate component or structure for preventing seawater from being induced is not required between the housing 10 and the floater 20 by appropriately designing the housing 10 and the floater 20.

Referring to FIGS. 3A and 3B, one of the stator 41 and the actuator 42 includes a coil 46, and the other includes a magnet 47. That is to say, the stator 41 may include the coil 46, the actuator 42 may include the magnet 47, and induced power may be generated in the stator 41 according to movement of the actuator 42. Conversely, the stator 41 may include the magnet 47, the actuator 42 may include the coil 46, and induced power may be generated in the actuator 42 according to movement of the actuator 42.

In FIG. 3A, the stator 41 has the coil 46 wound thereon and the actuator 42 has a plurality of magnets 47 formed by alternately arranging N and S poles. If the floater 20 is moved inside the housing 10 by waves, the actuator 42 moves along with the floater 20. Accordingly, the plurality of magnets 47 provided in the actuator 42 move around the stator 41 having the coil 46 wound thereon, the density of magnetic fluxes passing the cross section of the coil 46 may vary, thereby generating induced power. Conversely, in FIG. 3B, if the actuator 42 moves up and down with respect to the stator 41, as the coil 46 provided in the actuator 42 moves around the plurality of magnets 47 having N and S poles alternately arranged, the density of magnetic fluxes passing the cross section of the coil 46 may vary, thereby generating induced power.

The electricity obtained from the linear generation unit 40 may be stored in a storage device, such as a storage battery, or may be transmitted to land through an underwater cable to then be stored.

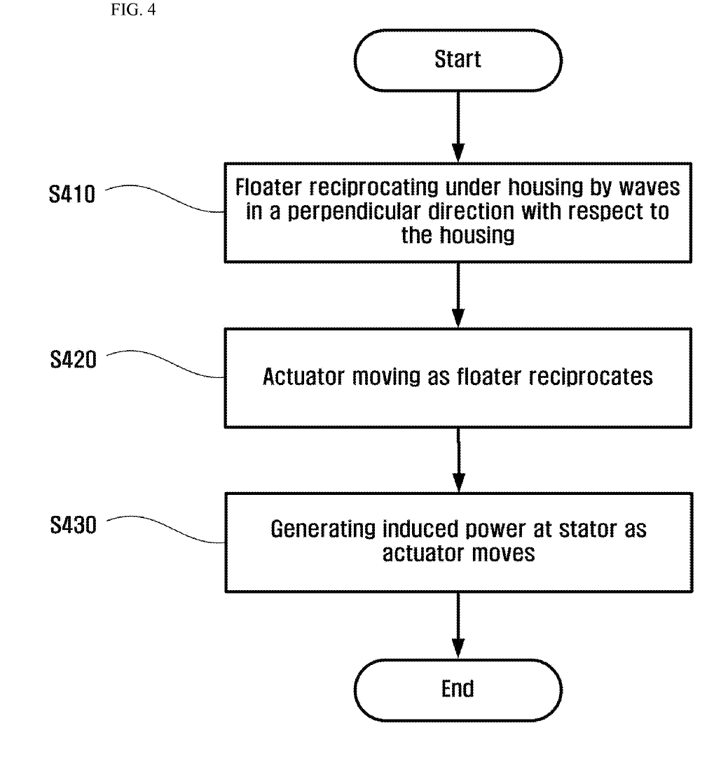

FIG. 4 is a flowchart of a method for wave generation of an underwater type according to an embodiment of the present invention.

Referring to FIG. 4, in the method for underwater wave generation for an underwater wave generation apparatus including a housing 10 having an open bottom end fixedly connected to the seafloor by a rope 55, a floater 20 having an open top end positioned in an inner space of a lower portion of the housing 10, a shaft 30 connected to a bottom surface of a top end of the housing 10, a stator 41 having a coil 46 mounted on the shaft 30, and an actuator 42 having a magnet 47 mounted on the floater h20, the method includes the floater 20 reciprocating under the housing 10 by waves in a perpendicular direction with respect to the housing 10 (S410), the actuator 42 moving according to the reciprocating of the floater 20 (S420), and generating induced power at the stator 41 according to the moving of the actuator 42 (S430). In addition, according to the moving of the actuator 42, the induced power generated at the stator 41 may be stored in a storage device, such as a storage battery, or may be transmitted to land through an underwater cable to then be stored.

As described above, the housing 10 is preferably shaped of a cylinder having a lower portion opened, and the floater 20 is preferably shaped of a two-stage cylinder having an upper portion opened. In addition, the magnets 47 mounted on the actuator 42 may have N and S poles alternately arranged.

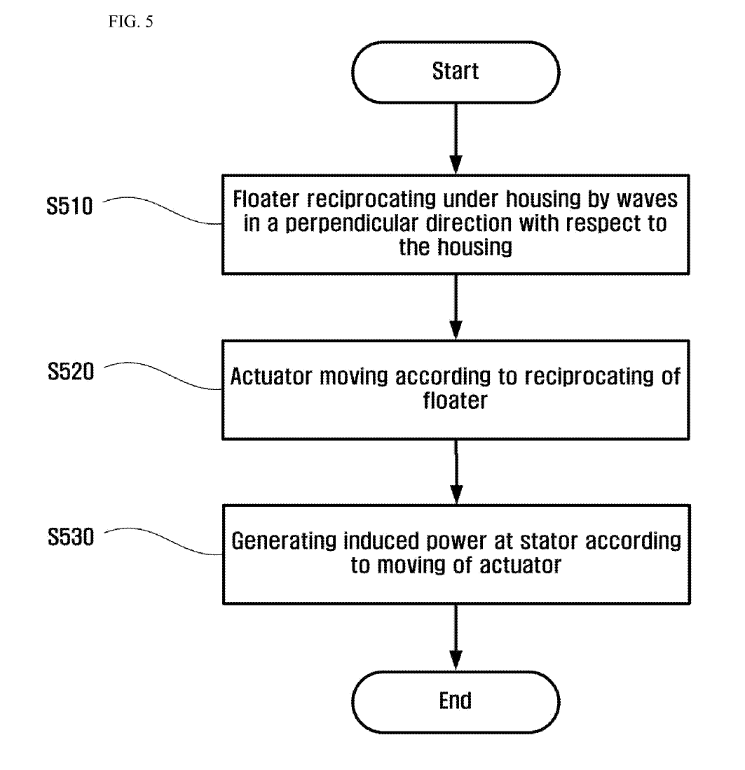

FIG. 5 is a flowchart of a method for wave generation of an underwater type according to another embodiment of the present invention.

Referring to FIG. 5, in the method for underwater wave generation for an underwater wave generation apparatus according to another embodiment of the present invention, the underwater wave generation apparatus including a housing 10 having an open bottom end fixedly connected to the seafloor by a rope 55, a floater 20 having an open top end positioned in an inner space of a lower portion of the housing 10, a shaft 30 connected to a bottom surface of a top end of the housing 10, a stator 41 having a magnet 47 mounted on the shaft 30, and an actuator 42 having a coil 46 mounted on the floater 20, the method includes the floater 20 reciprocating under the housing 10 by waves in a perpendicular direction with respect to the housing 10 (S510), the actuator 42 moving according to the reciprocating of the floater 20 (S520), and generating induced power at the stator 41 according to the moving of the actuator 42 (S530).

In addition, according to the moving of the actuator 42, the induced power generated at the actuator 42, specifically the coil 46, may be stored in a storage device, such as a storage battery, or may be transmitted to land through an underwater cable to then be stored.

In addition, as described above, the housing 10 is preferably shaped of a cylinder having a lower portion opened, and the floater 20 is preferably shaped of a two-stage cylinder having an upper portion opened. In addition, the magnets 47 mounted on the actuator 42 may have N and S poles alternately arranged.

Therefore, according to the present invention, the simplified underwater wave generation apparatus capable of easily installed, maintained and repaired is adopted, thereby obviating the need for fuel consumption required for power generation, and producing environmentally friendly renewal energy without exhausting pollutant materials according to power generation.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

1. An apparatus for wave generation of an underwater type, the apparatus comprising:
a housing formed to have an open bottom end and fixedly connected to the seafloor;
a shaft extending from a bottom surface of a top end of the housing;
a floater having a top end opened to surround the shaft, positioned at a lower portion of the housing and reciprocating in a perpendicular direction with respect to the housing; and
a linear generation unit converting kinetic energy based on the reciprocating motion of the floater into electrical energy.

2. The apparatus of claim 1, wherein the housing is shaped of a cylinder having a lower portion opened.

3. The apparatus of claim 1, further comprising a shaft holder fixing the shaft by connecting the shaft to the bottom surface of the top end of the housing.

4. The apparatus of claim 1, wherein the floater is shaped of a two-stage cylinder having an upper portion opened.

5. The apparatus of claim 1, further comprising a bush mounted on the shaft and restricting movement of the floater.

6. The apparatus of claim 1, wherein the linear generation unit comprises:
a stator mounted on the outer surface of the shaft; and
a actuator mounted on the inner surface of the shaft,
wherein induced power is generated by interaction of the stator and the actuator.

7. The apparatus of claim 6, wherein the stator is a coil and the actuator is a magnet, and induced power is generated at the stator by movement of the actuator.

8. The apparatus of claim 6, wherein the stator is a magnet and the actuator is a coil, and induced power is generated at the actuator by movement of the stator.

9. The apparatus of claim 1, further comprising:
a support fixedly installed on the seafloor; and
a rope connecting the support and the housing.

10. The apparatus of claim 9, wherein the housing is positioned underwater by the rope and floats.

11. A method for underwater wave generation for an underwater wave generation apparatus comprising a housing formed to have an open bottom end fixedly connected to the seafloor by a rope, a floater having an open top end positioned in an inner space of a lower portion of the housing, a shaft connected to a bottom surface of a top end of the housing, a stator having a coil mounted on the shaft, and a actuator having a magnet mounted on the floater, the method comprising:
the floater reciprocating under the housing by waves in a perpendicular direction with respect to the housing;
the actuator moving as the floater reciprocates; and
generating induced power at the stator as the actuator moves.

12. A method for underwater wave generation for an underwater wave generation apparatus comprising a housing having an open bottom end fixedly connected to the seafloor by a rope, a floater having an open top end positioned in an inner space of a lower portion of the housing, a shaft connected to a bottom surface of a top end of the housing, a stator having a magnet mounted on the shaft, and a actuator having a coil mounted on the floater, the method comprising:
the floater reciprocating under the housing by waves in a perpendicular direction with respect to the housing;
the actuator moving according to the reciprocating of the floater; and
generating induced power at the stator according to the moving of the actuator.

13. The method of claim 11, wherein the housing is shaped of a cylinder having a lower portion opened.

14. The method of claim 11, wherein the floater is shaped of a two-stage cylinder having an upper portion opened.

15. The method of claim 11, wherein the magnet has an N pole and an S pole alternately positioned.

16. The method of claim 11, further comprising storing the induced power.

17. The method of claim 12, wherein the housing is shaped of a cylinder having a lower portion opened.

18. The method of claim 12, wherein the floater is shaped of a two-stage cylinder having an upper portion opened.

19. The method of claim 12, wherein the magnet has an N pole and an S pole alternately positioned.

20. The method of claim 12, further comprising storing the induced power.
